(19) United States
(12) Patent Application Publication
(10) Pub. No.: US 2012/0191618 A1
(43) Pub. Date: Jul. 26, 2012

(54) Systems, Methods and Computer Program Products for Incentivizing Assignment or Licensing of Patents Rights

(76) Inventor: Cheryl Milone, New York, NY (US)

(21) Appl. No.: 13/244,974

(22) Filed: Sep. 26, 2011

Related U.S. Application Data
(60) Provisional application No. 61/434,867, filed on Jan. 21, 2011.

(51) Int. Cl. G06Q 50/00

(52) U.S. Cl. 705/310

(57) ABSTRACT

Systems, methods and computer program products are provided that create more efficient dynamics for private resolution of patent disputes. By providing defined discrete phases for acquiring information related to the validity of a patent, patent holders and potential licensees, potential stakeholders, or potential assignees will be incentivized to resolve their disputes in a mutually beneficial manner rather than wait for additional information that may dramatically increase or decrease the value of the asset.

### CROSS-REFERENCE TO RELATED APPLICATION

This application claims the benefit of U.S. Provisional Application Ser. No. 61/434,867, filed Jan. 21, 2011. The entire disclosure of that application is incorporated by reference as if set forth fully herein.

### FIELD OF THE INVENTION

The present invention pertains to the field of evaluation of patent assets.

### BACKGROUND OF THE INVENTION

In recent years, there has been an increased appreciation that patents can be valuable assets that can be monetized through brokerage and litigation. Under an economically efficient model, patent owners would, after accurate identification of potential licensees, potential stakeholders and potential acquirers of patent rights, quickly come to an agreement with those parties as to the value of the rights and then arrange for payment to be made for access to those rights. Unfortunately, the world of patent monetization is not efficient.

Monetization requires agreement, or in the alternative, dispute resolution such as negotiation to settlement, USPTO reexamination, or litigation. Where, as is generally the case, the parties disagree, the accused infringer's reaction to what may be a surprise assertion determines the level of disagreement. Thus, although the patent owner is unquestionably committed to monetization, the alleged infringer may or may not be amenable to it. Accordingly, when the patent owner asserts a litigation against the alleged infringer, a process begins that is driven by a timeline dependent on a number of factors such as: the selected forum, which typically the patentee initially selects, the state of the law (e.g., the uncertainty surrounding business method patents and damages), the court's local rules (e.g., the rocket docket) and even the assigned judge. A significant reason that patent monetization and transfer of rights to patents are inefficient is that all negotiations are made with the knowledge that an alternative to a private resolution of issues is patent litigation, which can be costly, time consuming and long in duration.

As stakeholders in the patent industry are aware, patent litigation can cost millions of dollars and can take years to complete. It also can involve appeals that further drain resources and extend the time before there is a final resolution of issues. Moreover, in many cases predicting the outcome of patent litigation and appeal (with 46% of appealed decisions being overturned) can be difficult.

Thus, there is a need to change the dynamics between patent holders and alleged infringers that will reduce the power of each party to delay entering into a transaction and thereby force the other party to endure patent litigation. As the patent holder generates the patent assertion, the patent holder places the economic value of the patent at risk. The alleged infringer is then forced to defend. This invention enables a change in dynamics in which the alleged infringer or third party drives settlement.

### SUMMARY OF THE INVENTION

In various embodiments, the present invention provides systems, methods and computer program products for changing the dynamics between patent holders and other parties to whom a patented right may be offered. These various embodiments may be automated on, for example, machines and involve the transformation of data in new and non-obvious ways.

Through the use of these inventions, patent holders can be encouraged to complete economic transactions in order to avoid having the assets remain part of a study that will request, receive and/or analyze information that is related to the validity of the patent. Parties that may become patent licensees or acquirers and thus become stakeholders may receive data to assess the patent brought to their attention and thereby minimize the time and the cost of responding to the assertion against them.

According, to a first embodiment, the present invention provides a patent information exchange system comprising: a computer comprising one or more processors that are operably coupled to and configured to execute a first protocol, a second protocol, and a third protocol, unless prior to the execution of any protocol or protocols a triggering event has occurred, wherein said triggering event is the assignment or licensing of rights to a patent, wherein: (a) the first protocol comprises displaying on a publicly available platform, information sufficient to identify the patent or a technology description related to the patent; (b) the second protocol comprises receiving a set of information relating to the validity or infringement of one or more claims of the patent; and (c) the third protocol comprises making the set of information relating to the validity or infringement of one more claims of the patent available to an entity. Thus, if no triggering event occurs, the third protocol may in some embodiments form a new set of information that is stored in a tangible medium as a data package. This information may be the information relating to the validity or infringement of a claim or claims and may be what is sent to the entity. If a triggering event occurs, the computer may cause a file that stores data identifying the patent to be modified by or to have associated with it information that denotes that a triggering event has occurred. This denotation may specify the event or only that a triggering event has occurred. The notation or other change in the file may itself cause all subsequent protocols not to be commenced or it may merely be a contemporaneous event with another instruction that is sent to the computer program product (or withheld from the computer program product) that causes subsequent protocols not to be commenced.

According to a second embodiment, the present invention provides a patent information exchange system comprising: a computer that comprises one or more processors that are operably coupled to and configured to execute a first protocol, a second protocol, a third protocol, and a fourth protocol, unless prior to the execution of any protocol or protocols a triggering event has occurred, wherein said triggering event is the assignment or licensing of rights to the patent, wherein: (i) the first protocol comprises providing notice of receipt of information identifying the patent; (ii) the second protocol comprises displaying on a publicly available platform, information sufficient to identify the patent; (iii) the third protocol comprises receiving a set of information relating to the validity or infringement of one or more claims of the patent; and (iv) the fourth protocol comprises making the set of information relating to the validity or infringement of one or more claims of the patent available to an entity.

According to a third embodiment, the present invention provides a patent information exchange system comprising: (a) a data storage unit having stored therein information that identifies a patent; and (b) a computer coupled to said data storage unit that is configured to execute a first protocol, a second protocol, a third protocol, a fourth protocol and a fifth protocol, unless prior to the execution of any protocol or protocols a triggering event has occurred, wherein the triggering event is the assignment or licensing of rights to the patent, wherein (i) the first protocol comprises providing notice of input of the patent into the data storage unit; (ii) the second protocol comprises displaying on a publicly available platform, information sufficient to identify the patent; (iii) the third protocol comprises receiving a first set of information relating to the validity or infringement of one or more claims of the patent; (iv) the fourth protocol comprises receiving a second set of information relating to the validity or infringement of one or more claims of the patent; and (v) the fifth protocol comprises making at least one of the first set of information or second set of information available to an entity.

According to a fourth embodiment, the present invention provides a patent information exchange system that comprises: (a) a data storage unit having stored therein information that identifies a patent; (b) a subscription module; and (c) a computer coupled to the data storage unit that is configured to execute a first protocol, a second protocol, a third protocol, a fourth protocol and a fifth protocol, unless prior to the execution of any protocol or protocols a triggering event has occurred, wherein the triggering event is the assignment or licensing of rights to the patent, wherein (i) the first protocol comprises providing notice of input of the patent into the data storage unit; (ii) the second protocol comprises displaying on a publicly available platform, information sufficient to identify the patent; (iii) the third protocol comprises receiving a first set of information relating to the validity or infringement of one or more claims of the patent; (iv) the fourth protocol comprises receiving a second set of information relating to the validity or infringement of one or more claims of the patent; and (v) the fifth protocol comprises making at least one of the first set of information or the second set of information available to a set of entities who are identified in the subscription module.

### DETAILED DESCRIPTION OF THE INVENTION

According to one embodiment, the present invention provides a patent information exchange system. The system may comprise a computer that contains one or more processors that are operably coupled to and configured to execute one more protocols. In some embodiments, the protocols are contained on a machine and are capable of transforming data, storing transformed data, displaying transformed data and/or sending the transformed data in electronic form simultaneously to a plurality of entities.

Optionally, the system also comprises a data storage unit that may have information stored therein that identifies one or more patents. This information may be indexed. For example, the indexing may be by patent number and country or jurisdiction of origin. The information may contain or be linked to a file that contains one or more of the text of the patent, an image of the patent (for example, PDF), the owner(s) of the patent as listed on the face of the patent, the owner(s) of the patent as identified in a public database, the claims of the patent, and identification of the inventor(s) or combinations thereof. The data storage unit may be located and configured to be in physical communication with the computer. Alternatively, it may be located remotely from the computer. Further, in some embodiments, the data storage unit may be temporary or permanent memory within the computer.

The computer may be operably coupled to the data storage unit. By being “operably coupled” to the data storage unit, the computer can retrieve information from the data storage unit and send information to the data storage unit. Further, the computer can cause information in the data storage unit to be transformed into new data and stored therein, thereby overwriting previously stored data. The phrase “operably coupled” and the term “coupled” may be used interchangeably.

The computer may also be configured to execute and to be operably coupled to a set of instructions that are stored on the computer's hard drive, on software, on a network or in a cloud. The set of instructions may be in the form of protocols. As persons of ordinary skill in the art are aware, when a computer executes a computer program product with a plurality of protocols, each protocol may be stored as a separate and discrete set of instructions or each protocol may be stored as a subpart of a larger set of instructions.

In one embodiment, the computer may be configured to execute a first protocol, a second protocol, a third protocol, and a fourth protocol. In a default mode the computer may be configured to execute each of these protocols in order. The computer may also be configured not to proceed from one protocol to the next if a triggering event occurs. These protocols may for example be stored in a computer program product that exists in a non-transitory medium.

The triggering event may, for example, comprise the assignment or licensing of rights to the patent at issue. The computer may be made aware of the transfer or granting of rights by for example, receiving input from the assignor, assignee, licensor, licensee, administrator of the system or other third party. Additionally or alternatively, the computer may be configured to mine a publicly available database for information that records the change in ownership. For example, the computer may be configured to mine the records of the assignment branch of the USPTO.

The first protocol may comprise providing notice of input of the patent into a data storage unit. The notice may be sent to the patent holder or to an accused infringer or potential licensee, potential acquirer or potential stakeholder or combination thereof. This notice may be sent via electronic means, e.g., e-mail or posted on a secure password protected site, or it may be sent in hard copy, e.g., traditional or overnight mail, or via facsimile or it may be sent by a combination of means. Thus, in some embodiments this notice may be non-public. This first protocol is optional, and in some embodiments may be omitted, in which case each subsequent protocol may be renumbered with a lower ordinal number.

The second protocol comprises displaying on a publicly available platform, information that is sufficient to identify the patent. This information may for example comprise one or more of the patent number, patent country, text of the patent or image of the patent. It may also comprise information identifying the owner of the patent and or inventor(s). The computer may be configured to execute the second protocol only after a first period of time after executing the first protocol. By way of a non-limiting example, this time period may be between one day and one month or between one day and two weeks or between one week and two weeks. During this time period, the patent holder may be aware that his or her patent is in a queue to be placed on a public platform that requests information that will implicate the validity of the patent.

The public platform may, for example, take advantage of crowdsourcing strategies and request relevant prior art. An example of using crowdsourcing to obtain relevant prior art is currently being implemented by Article One Partners.

With the knowledge that the patent will be the subject of a study (which may be provided either by public notice that the patent will be part of the study or by personal notice being sent to the patent holder), the patent holder who wishes to avoid having a request for information that implicates the validity or infringement of the study be made, may be more likely to complete a deal that either licenses or assigns rights to patent. Thus, particularly for the entity whose business model is based at least in part if not substantially or completely on generating revenue for access to patent rights for technologies that it does not practice, knowledge that its patent will be subjected to greater scrutiny may encourage the patent owner to enter into an agreement that based on the additional risk of public scrutiny, commands a lower price.

The incentive to reach an early agreement may also be felt by the potential acquirer, potential stakeholder or potential licensee. In an otherwise private discussion, the potential acquirer, potential stakeholder or potential licensee might express concerns about the questionable validity of the patent to the patent owner to bring the price down. However, if the potential acquirer, potential stakeholder or potential licensee wants to obtain exclusive rights, it may not want the patent to be subjected to greater third party scrutiny because it will one day become the owner of the patent and should it need to enforce the patent, during any such litigation it would need to produce to any accused infringer, the information that was collected (or it may need to submit it to the Patent Office in other pending ex parte proceedings).

Should the system not be made aware of a triggering event, then the computer would execute the second protocol, which displays on a publicly available platform information sufficient to identify the patent. Optionally, the display on the publicly available platform may coincide with a request for information that has bearing on the validity or infringement of one or more claims of the patent and an opening of the period for which the computer will receive such information. However, the system may also be configured such that no information may be received for a certain amount of time after the posting of the information. This interval may be referred to as a second period of time in alternative embodiments of the second protocol, which spans from the posting of the information to the start of the time period in which information may be received.

The third protocol, which may be executed immediately after the second protocol or after the second defined period of time, provided that no triggering event has occurred, causes the system to be able to receive a set of information relating to the validity or infringement of the patent. The information received in the third protocol may be indexed or otherwise associated with the information that identifies the patent in a data storage unit. Furthermore, it may be stored in the data storage unit or elsewhere.

As noted above, in some embodiments, the computer may be configured to cease receiving references after execution of the third protocol for a third period of time. This period may for example be from one day to two weeks or from one day to one week or from one week to two weeks. If no triggering event occurs during this time period, then the computer will execute the fourth protocol, in which the information is sent to an entity or plurality of entities. This information may be sent as a data package or be sent to (or uploaded onto) a website to which the entity or entities have access. Under this latter scenario, notice may be sent to the entity or entities that the information has been posted on the site. The site may be password protected or otherwise encrypted.

In some embodiments, the system is configured such that after a triggering event, one or more of the following events occurs: the information identifying the patent is removed from the data storage unit, the information identifying the patent is removed from the publicly available platform, any information that is received relating to the validity of the patent is deleted or notice is provided that a transfer of rights has occurred. These acts, as well as the others of the system may be automated and may cause a transformation of data, as well as transformation of a data file.

As persons of ordinary skill in the art will appreciate, the system may be configured to run simultaneously the aforementioned protocols for a plurality of patents. These patents may have a common owner or different owners and they be directed to the same or different technology fields. Further, the protocols may start on the same day or on different days.

In some embodiments, the patent or patents are owned by a practicing litigation entity, which may also be referred to as a non-practicing entity.

The system may further be configured to send notice of the start or end of each or all protocols. This notice of may be automated and may be sent to the entity and/or patent owner.

In some embodiments, the above referenced system may be changed and instead comprise five protocols. The first three protocols may be the same. However, there may be a fourth protocol that comprises receiving a set of information relating to the validity of one or more claims of said patent. The information that is received during the third protocol and during the fourth protocol may be differentiated by time of receipt or number of references or other information that is received. Thus, during the third protocol the information that is received may be a first set of information, whereas during the fourth protocol, the information that is received may be a second set of information. The first set of information may comprise all of the information that is submitted within a first time period, e.g., from one day to one week or from one day to two weeks or from one week to two weeks. Alternatively, it could be defined as the first 10 to 100 references or the first 20 to 50 references. The second set of information may be all information that is received after the first set of information or the next 10 to 100 references or the next 20 to 50 references or the information that is received in the next one day to one week or from one day to two weeks or next one week to two weeks. Preferably, each study will have a closing date after which no further information is accepted. As persons of ordinary skill in the art are aware these standards are easily automated.

When there are five protocols, the fourth protocol of the previous embodiment would be denoted as the fifth protocol, and comprise making at least one of the first set of information or second set of information available to an entity. The system may be configured to execute the fifth protocol either before and/or after the fourth protocol.

The system may also be designed such that the first protocol is omitted. Thus, in some embodiments notification to the patent owner of input of the patent into the data storage unit is not required.

The system may further be designed such that the entity that receives the information at the end of any protocols, e.g., the last protocol, is a party that has been accused of infringement of the patent, has paid for access to the information or has agreed to or intends to file a request for reexamination of the patent. In some embodiments, at least two, at least three, at least five, at least ten or at least twenty entities are simultaneously provided with the information.

The aforementioned systems may be used to encourage the settlement of a litigation, the prevention of a litigation, or a transfer or licensing of patent rights. These uses may involve a method comprising a potential buyer, stakeholder, or licensee of the patent or portfolio, providing identification of the patent to the system, wherein the potential buyer, stakeholder, or licensee is the entity that receives the information relating to the validity or infringement of the patent.

According to another embodiment, the present invention provides another patent information exchange system that encourages efficient monetization of patent. This system comprises a data storage unit, a subscription module and a computer.

The data storage unit may be configured as described above, and is optional.

The subscription module may comprise data that identifies one or more parties that have paid for access to one or more of a notice sent out by the system, information received by the system or notice of a request to purchase one or more patents identified in the data storage unit. The subscription module may exist in the form of computer hardware or software or a combination thereof and may be located in the same location as the data storage unit and/or the computer. Further, both the data storage unit and the subscription module may be part of a larger memory storage unit.

The computer may be coupled to either or both of the data storage unit and the subscription module. As with the embodiments described above, the computer may be configured to execute the recited protocols, e.g., a first protocol, a second protocol, a third protocol, a fourth protocol and a fifth protocol, unless prior to the execution of any protocol or protocols a triggering event has occurred, wherein the triggering event is the assignment or licensing of rights to the patent. Similarly, each of the protocols may be defined as described above. After a triggering event, a data file may be modified and/or the computer program product can be directed not to enter protocols that have not at the time of receipt of information corresponding to the triggering event, been entered.

In one embodiment, subscribers may receive notice of receipt of the system of information relating to validity of the patent, e.g., the first set of information and/or the second set of information. Additionally, in some embodiments, the subscribers may have access to the first set of information and/or to the second set of information. Furthermore, the subscribers may be entities who at the completion of the fifth protocol receive the information.

In some embodiments, the subscription module comprises information sufficient to identify a first subscriber and a second subscriber and the fifth protocol is configured to send either the first set of information or the second set of information or both sets of information to the first subscriber prior to sending the first set of information or the second set of information or both sets of information to said second subscriber. Additionally, in the system the computer may be further configured to send the first set of information to the set of entities or a subset of the entities before executing said fourth protocol.

The systems may also contain one or more of an output device, a graphic user interface, and an input device. Any or all of such devices may be operably coupled to the computer and/or database.

The systems, methods and computer program products of the various embodiments of the present invention may be implemented through technologies that are now known or that come to be known and that may be appreciated by persons of ordinary skill in the art as being of use in connection with the present invention. For example, the instructions for implementing the above-referenced methods may be embodied in a computer program product and carried out on hardware, software or a combination thereof that permits the development and use of systems that comprise components that are operably coupled to one another.

The various embodiments of the present invention may be performed by one or more computers that have access to networks or communication devices in order to permit them to access and to interact with the necessary information sources. Thus, in various embodiments, the methods are accomplished through the use of a computer that comprises a central processing unit and one or more input/output devices.

The systems, methods and computer program products may be implemented through one or more computers or central processing units that are configured to automate the methods of the present invention. The phrase “central processing unit” and the abbreviation “CPU” are used interchangeably and refer to an electronic circuit that can execute a computer program and can accomplish electronic communication through for example a processor. A processor is the part of a computer that can execute instructions and manipulate data.

The system may have specific software, including a browser that standardizes communication with network servers. These servers may be any devices that are capable of receiving, delivering and sending email messages, text messages and/or other messages that are sent to it. Thus, a server may comprise a storage device, an input device, an output device, a memory device, a processor and a communication interface.

Persons who are interested in utilizing the methods, systems and computer products of the present invention may communicate with the entity (that may be referred to as a provider) or computer that implements the methods through one or more input devices, output devices, and communication interfaces. An input device is any device that may be used to input, to select and/or to manipulate information. By way of example, input devices include, but are not limited to, a keyboard, a mouse, a graphic tablet, a joystick, a light pen, a microphone, a smart phone and a scanner. An output device may be any device that enables a computer to present information to a user, and includes, but is not limited to, a video display, a printer, and an audio speaker.

A communication interface is a tool for receiving input and sending output. Thus, it is or is part of a portal or is operably coupled to a portal. By way of example, communication interfaces may include but are not limited to a modem, a network interface card and the requisite software such as for protocol conversion and data conversion to communicate through e.g., a LAN, WAN or otherwise over the Internet. A “portal” is a method, system or apparatus for connecting to a network. For example, a portal may be a means of accessing the Internet. The system may receive and send data through one or more portals.

The aforementioned data storage unit may be stored on or in the form of one or more memory devices. A memory device is a device that can store, retrieve or facilitate the retrieval of data. By way of example, a memory device may comprise one or more of Random Access Memory (RAM), Read Only Memory (ROM), a magnetic drive, a Digital Video Disk (DVD) drive, or removable media storage. This information may, for example, be stored in a database.

In another embodiment, the present invention provides a computer program product stored in a tangible medium. The medium may be a non-transitory tangible computer readable storage medium comprising a set of executable instructions that are capable of directing a computer to execute the necessary steps for modules that implement the protocols of the invention to perform their intended purposes or to effectuate any of the methods described herein. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

I claim:

1. A patent information exchange system comprising: a computer comprising one or more processors that are configured to execute a first protocol, a second protocol, and a third protocol, unless prior to the execution of any protocol or protocols a triggering event has occurred, wherein said triggering event is the assignment or licensing of rights to a patent, wherein
(a) said first protocol comprises displaying on a publicly available platform, information sufficient to identify said patent or a technology description related to said patent;
(b) said second protocol comprises receiving a set of information relating to the validity or infringement of one or more claims of said patent; and
(c) said third protocol comprises making the set of information relating to the validity or infringement of one more claims of said patent available to an entity.

2. The system of claim 1 further comprising a protocol prior said first protocol comprising providing notice of input of said patent into a data storage unit.

3. The system of claim 1, wherein the system is configured to execute said protocols for a plurality of patents.

4. The system of claim 3, wherein said plurality of patents have a common owner.

5. The system of claim 4, wherein the common owner is a non-practicing entity.

6. The system of claim 3, wherein the plurality of patents share a technology field.

7. The system of claim 1, wherein the computer is configured to send notice of execution of the first protocol to an owner of said patent.

8. The system of claim 1, wherein the computer is configured to send notice of receipt of said set of information to an owner of said patent.

9. The system of claim 1, wherein said entity has been accused of infringement of said patent.

10. The system of claim 1, wherein said entity is a member of group that has paid for access to said set of information.

11. The system of claim 1, wherein the triggering event further comprises registering a recordation of assignment of said patent rights with a governmental body.

12. The system of claim 1, wherein after said triggering event, said information sufficient to identify said patent is removed from said publicly available platform.

13. The system of claim 1, wherein said computer is configured to execute said second protocol in the absence of a triggering event after a first period of time after executing the first protocol.

14. The system of claim 1, wherein said computer is configured to execute said third protocol in the absence of a triggering event after a second period of time after executing the second protocol.

15. The system of claim 2 further comprising a data storage unit, wherein said data storage unit stores information sufficient to identify said patent.

16. A method to encourage a transferring or licensing of patent rights comprising: a potential buyer, potential licensee or potential stakeholder of patent rights providing identification of said patent rights to the system of claim 1, wherein said potential buyer, said potential licensee or said potential stakeholder is said entity.

17. A patent information exchange system comprising a computer comprising one or more processors that are configured to execute a first protocol, a second protocol, a third protocol, and a fourth protocol unless prior to the execution of any protocol or protocols a triggering event has occurred, wherein said triggering event is the assignment or licensing of rights to a patent, wherein
(a) said first protocol comprises providing notice of input of said patent into a data storage unit;
(b) said second protocol comprises displaying on a publicly available platform, information sufficient to identify said patent;
(c) said third protocol comprises receiving a set of information relating to the validity or infringement of one or more claims of said patent; and
(d) said fourth protocol comprises making said set of information relating to the validity or infringement of one or more claims of said patent available to an entity.

18. A patent information exchange system comprising:
(a) a data storage unit having stored therein information that identifies a patent;
(b) a subscription module; and
(c) a computer comprising one or more processes coupled to said data storage unit that is configured to execute a first protocol, a second protocol, a third protocol, a fourth protocol and a fifth protocol, unless prior to the execution of any protocol or protocols a triggering event has occurred, wherein said triggering event is the assignment or licensing of rights to said patent, wherein
(i) said first protocol comprises providing notice of input of said patent into said data storage unit;
(ii) said second protocol comprises displaying on a publicly available platform, information sufficient to identify said patent;
(iii) said third protocol comprises receiving a first set of information relating to the validity or infringement of one or more claims of said patent;
(iv) said fourth protocol comprises receiving a second set of information relating to the validity or infringement of one or more claims of said patent; and
(v) said fifth protocol comprises at least one of making the first set of information or second set of information available to a set of entities who are identified in said subscription module.

19. The system of claim 18, wherein said subscription module comprises information sufficient to identify a first subscriber and a second subscriber and the fifth protocol is configured to send either said first set of information or said second set of information or both sets of information to said first subscriber prior to sending said first set of information or said second set of information or both sets of information to said second subscriber.

20. The system of claim 19, wherein the computer is further configured to send said first set of information to said first subscriber before executing said fourth protocol.
